(19) United States
(12) Patent Application Publication
(10) Pub. No.: US 2020/0056725 A1
(43) Pub. Date: Feb. 20, 2020

(54) System And Method For Extracting A Buried Pipe

(71) Applicant: Earth Tool Company LLC, Lake Mills, WI (US)

(72) Inventors: Steven W. Wentworth, Scottsdale, AZ (US); Robert F. Crane, Nekoosa, WI (US); Mark D. Randa, Oconomowoc, WI (US); Kelvin C. Aus, Watertown, WI (US)

(21) Appl. No.: 16/539,311

(22) Filed: Aug. 13, 2019

Related U.S. Application Data
(60) Provisional application No. 62/718,463, filed on Aug. 14, 2018.

(51) Int. Cl. F16L 1/032; F16L 1/06

(52) U.S. Cl. CPC F16L 1/032; F16L 1/065

(57) ABSTRACT

A method for breaking the friction between a buried pipe section and its surrounding soil. A linear actuator or a pneumatic impact mole pushes on one end of the pipe section while a pipe extractor pulls on the opposing end of the pipe section. In an alternative embodiment, a device is used to excite the pipe section's natural vibrational frequency while a pipe extractor pulls on one end of the pipe section. After the friction between the pipe section and its surrounding soil is broken, the pipe extractor may remove the pipe section from its borehole. In another embodiment, the pipe section may be cut into smaller sections and each section may be individually removed from the ground using a pipe extractor. Alternatively, the smaller pipe sections may be individually loosened from the surrounding soil and then rejoined before being removed from the ground by a pipe extractor.

### SUMMARY

The present invention is directed to a system comprising a pipe having a first end, a second end, and a middle section. The middle section is below ground. The system also comprises a device engaged with the first end of the pipe and selected from a group consisting of a linear actuator or a pneumatic impact mole. The system further comprises an apparatus comprising a stationary support structure and a carriage movable relative to the stationary support structure. The apparatus further comprises a pipe clamp assembly supported by the carriage and in gripping engagement with the second end of the pipe.

The present invention is also directed to a system comprising an elongate underground pipe having a first exposed end, an opposed second exposed end, and a natural vibrational frequency. The system also comprises a first apparatus mechanically coupled to the pipe and configured to excite the pipe's vibrational frequency. The system further comprises a second apparatus mechanically coupled to the pipe and configured to impart a pulling force to one of the exposed ends of the pipe.

The present invention is also directed to a method of extracting an elongate underground pipe having exposed sections extending through a plurality of spaced pits. The pits include adjacent first and second pits. The method comprises the step of cutting the pipe section within the first pit to form a ground-entering pipe segment having a first free end and a ground-entering pipe segment having a second free end. The method further comprises the step of cutting the pipe section within the second pit so as to form two ground-entering pipe segments, and applying a first ground-dislodging axial force to the pipe segment terminating at the first free end. Thereafter, the pipe segments within the second pit are joined. After the pipe segments are joined, a second ground-dislodging force is applied to the pipe segment terminating at the first free end.

The present invention is further directed to a method of extracting an elongate underground pipe having exposed sections extending through a plurality of spaced pits. The pits include adjacent first and second pits. The method comprises the step of cutting the pipe section within the first pit to form a ground-entering pipe segment having a first free end and a ground-entering pipe segment having a second free end. The method also comprises the step of cutting the pipe section within the second pit to form a ground-entering pipe segment having a first free end and a ground-entering pipe segment having a second free end. The method further comprises the step of applying a first ground-dislodging axial force to the pipe segment terminating at the first free end within the first pit. Thereafter, a second ground-dislodging axial force is applied to the pipe segment terminating at the first free within the second pit.

### BRIEF DESCRIPTION OF THE DRAWINGS

FIG. 1 is an isometric view of an elongate pipe buried beneath the ground surface. The soil surrounding the pipe is shown in a cube-like form. A pair of excavation pits are formed in the soil. Each pit exposes a section of the pipe to the ground surface.

FIG. 2 is a right side perspective view of the buried pipe and excavation pits shown in FIG. 1. A portion of the ground has been cut away to better view the pits and a segment of the pipe situated within each pit has been cut away to form a pipe section extending between the pits. A portion of the buried pipe section is shown in dotted lines.

FIG. 3 is a right side perspective view of the buried pipe section and excavation pits shown in FIG. 2. A linear actuator is engaged with an end of the pipe section in the first pit and a pipe extractor is engaged with an end of the pipe section in the second pit. A power pack is positioned on the ground surface adjacent each pit.

FIG. 4 is an enlarged view of area A shown in FIG. 3.

FIG. 5 is a front perspective view of the pipe extractor shown in FIG. 3.

FIG. 6 is a rear elevational view of the pipe extractor shown in FIG. 5. The clamps are in a closed position and the shear blade is in a cutting position.

FIG. 7 is a left side perspective view of the buried pipe section, excavation pits and devices shown in FIG. 3, but an end of the pipe section extends farther into the second pit.

FIG. 8 is a chart showing an example of cyclic load that may be applied to the pipe section.

FIG. 9 is a left side perspective view of the buried pipe section and excavation pits shown in FIG. 2. A pneumatic impact mole is engaged with the end of the pipe section in the first pit and the pipe extractor is engaged with the end of the pipe section in the second pit. A power pack is positioned on the ground surface adjacent the second pit.

FIG. 10 is a right side perspective view of the buried pipe section and excavation pits shown in FIG. 2. An eccentric mass vibrator is attached to the end of the pipe section in the first pit and the pipe extractor is engaged with the end of the pipe section in the second pit. A power pack is positioned on the ground surface adjacent each pit.

FIG. 11 is the right side perspective view shown in FIG. 10, but the eccentric mass vibrator has been removed from the first pit and attached to the end of the pipe section in the second pit. Both power packs are positioned on the ground surface adjacent the second pit.

FIG. 12 is a right side perspective view of the buried pipe section and excavation pits shown in FIG. 2. A pipe extractor is engaged with the end of the pipe section in the second pit. A fluid exciter is positioned on the ground surface adjacent the second pit and adjacent a power pack.

FIG. 13 is a right side perspective view of the buried pipe section, excavation pits, and devices shown in FIG. 3. A fluid exciter is shown positioned on the ground surface adjacent the first pit and adjacent a power pack.

FIG. 14 is a right side perspective view of a series of pipe sections buried beneath the ground surface. The soil surrounding the pipe sections is shown in a cube-like form. A series of excavation pits are formed in the ground. Each pit exposes the ends of the pipe sections to the ground surface. A portion of the ground has been cut away to better view the pits and the buried portions of the pipe sections are shown in dotted lines.

FIG. 15 is a right side perspective view of the buried pipe sections and excavation pits shown in FIG. 14. A pipe extractor is engaged with an end of a pipe section in the first pit.

FIG. 16 is the right side perspective view shown in FIG. 15, but the pipe extractor has been moved to the second pit and is engaged with an end of a different pipe section.

FIG. 17 is a right side perspective view of the buried pipe sections, excavations pits and pipe extractor shown in FIG. 15, but the ends of the adjacent pipe sections in the second pit are much closer together.

### DETAILED DESCRIPTION

Underground utility pipelines, such as gas, sewer or water pipes are normally installed within a borehole drilled horizontally beneath the ground surface. Such pipes periodically need to be extracted and replaced. Pipe extractors known in the art may be used as one method of extracting a pipe from its borehole. An example of a pipe extractor is described in U.S. Patent Publication No. 2019/0049040, authored by Wentworth et al., the entire contents of which are incorporated herein by reference. Another example of a pipe extractor is described in U.S. Pat. No. 7,128,499, issued to Wentworth, the entire contents of which are incorporated herein by reference.

Pipe extractors are configured to grip an exposed end of the buried pipe and apply a ground-dislodging axial force. The applied force pulls the buried pipe from its borehole. As the pipe is pulled from the soil, a shear blade included in the pipe extractor cuts the pipe into smaller sections. Prior to removing the pipe from its borehole, a new pipe is attached to an exposed end of the pipe opposite the end engaged with the pipe extractor. The new pipe is pulled into the borehole as the old pipe is extracted.

The ability of a pipe extractor to remove a pipe from its borehole is limited by the pipe's tensile yield strength and the friction between the pipe and the surrounding soil. Long term contact with the soil applies a frictionally induced shear stress on the pipe. If the pipe is not loosened from the surrounding soil, the shear stress may cause the pipe to break as it is pulled axially by the pipe extractor. The longer the pipe, the harder it is to break the pipe loose from the soil.

The maximum length that can be extracted without breaking the pipe is equal to the tensile yield strength of the pipe divided by the force per foot of pipe length required to break the pipe loose from the soil. The force required to break a pipe loose from the soil is the product of the surface area per foot of length of pipe multiplied by the shear stress. For example, 1.0″ nominal schedule 40 pipe used for natural gas distribution normally has a tensile yield strength of 20,660 pounds and a surface area per foot of 49.56 square inches. If the shear stress is 3.5 psi, the force required to break the pipe loose from the soil will equal 173 pounds of force per foot. Thus, the maximum length of pipe that can be extracted without breaking the pipe in such example is 119 feet.

Due to the length limitations, pipe extractors are generally used to extract lateral pipelines, not main pipelines. Lateral pipelines connect a main pipeline to residences or small businesses and typically have a smaller cross-sectional diameter than a main pipeline. Lateral pipelines typically have a length of less than 100 feet. In contrast, main pipelines typically have a length of at least 200 feet. Most main pipelines have a length of around 500 feet. Because main pipelines are so long, damaged main pipelines are rarely extracted from the surrounding soil. Rather, damaged main pipelines may be repaired or replaced using other methods known in the art, such as pipe lining or pipe bursting.

Main pipelines have been known to be extracted using a pneumatic rammer known in the art. The nose of the rammer is engaged with an open end of the pipe and is attached to cable disposed throughout the length of the pipe. The cable is attached to a winch. The rammer thrusts forward against the end of the pipe while simultaneously being pulled through the surrounding soil by the cable and winch. The thrust force applied to the end of the pipe forces the pipe to move axially within its borehole. The pipe is cut into sections by a chop saw as the pipe exits the surrounding soil.

One problem with the pneumatic hammer extraction method is that the pipe must be cut without cutting the cable disposed within the pipe, which can be difficult. Another problem is that the rammer exhausts oily air. If a new pipe is being pulled into the surrounding soil behind the rammer, the oily air may coat the inside of the new pipe. Such coating will need to be cleaned from the pipe if the pipe is used for gas or water.

It is possible to use a pipe extractor to extract a main pipeline from its borehole if the friction between the pipe and the soil is first broken. If the friction between the soil and pipe is broken, the shear stress significantly drops. Once the shear stress drops, the pipe extractor can remove a much greater length of pipe from the borehole without breaking the pipe. The present disclosure is directed to a plurality of different methods that may be used to break the friction between a pipe and the surrounding soil.

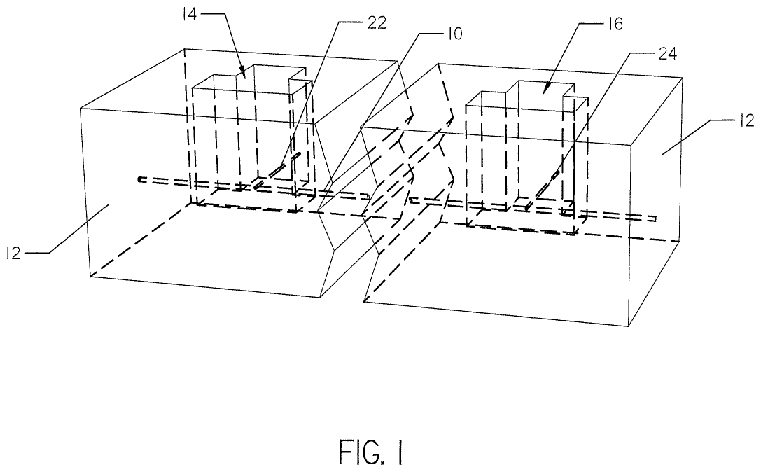

Turning to FIG. 1, an elongate main pipe 10 is shown installed underground. The pipe 10 is surrounded by soil 12 and has a length of at least 200 feet. The surrounding soil 12 may include clay, rock or other materials found under the earth surface. A first and second excavation pit 14 and 16 are formed in the soil 12 so as to expose sections of the pipe 10. The pits 14 and 16 also expose a first and second lateral pipe 22 and 24. Each lateral pipe 22 and 24 is connected to the main pipe 10.

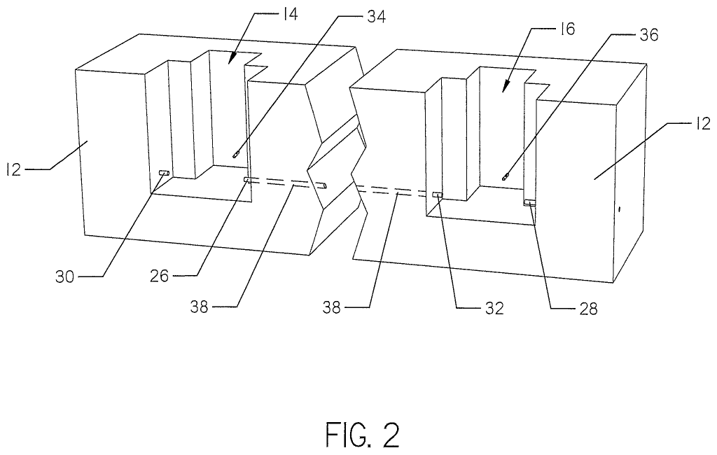

Turning to FIG. 2, the pipe 10 has been cut in the first pit 14 to form a first ground-entering pipe segment having a first free end 26 and a second ground-entering pipe segment having a second free end 30. Likewise, the pipe 10 has been cut in the second pit 16 to form a first ground-entering pipe segment having a first free end 28 and a second ground-entering pipe segment having a second free end 32. Each lateral pipe 22 and 24, shown in FIG. 1, has also been cut to expose a free end 34 and 36.

The exposed first free end 26 in the first pit 14 is joined to the exposed second free end 32 in the second pit 16. The ends 26 and 32 are joined by a middle pipe section 38 that is surrounded by soil 12. The pipe section 38 is the area of the main pipe 10 to be extracted and replaced with a new pipe. Once the new pipe is installed, its ends are joined to the free end 30 in the first pit 14 and the free end 28 in the second pit 16. The new pipe will also be joined to the ends 34 and 36 of the lateral pipes 22 and 24.

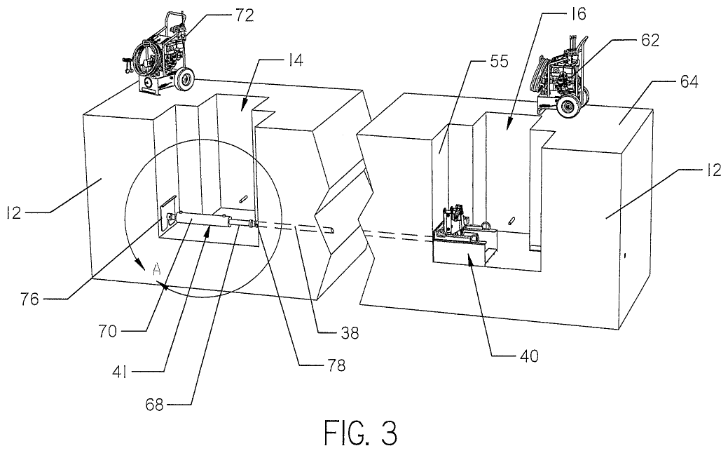

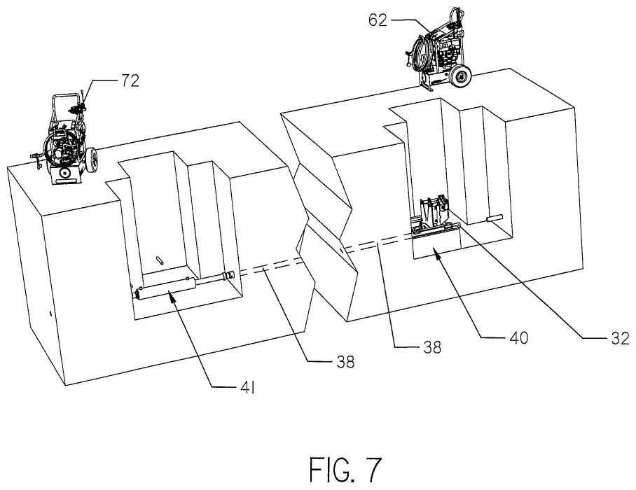

Turning to FIG. 3, one method of breaking the friction between the pipe section 38 and the soil 12 is shown. A linear actuator 41 statically pushes against the first free end 26 of the pipe section 38 in the first pit 14. At the same time, a pipe extractor 40 statically pulls on the second free end 32 of the pipe section 38 in the second pit 16. The pipe section 38 is considered broken free from the soil 12 if the pipe extractor 40 is able to remove a portion of the pipe section 38 from its borehole. For example, FIG. 7 shows the second free end 32 of the pipe section 38 extended farther into the second pit 16 than is shown in FIG. 2. Such movement indicates that the pipe section 38 has broken free from the soil.

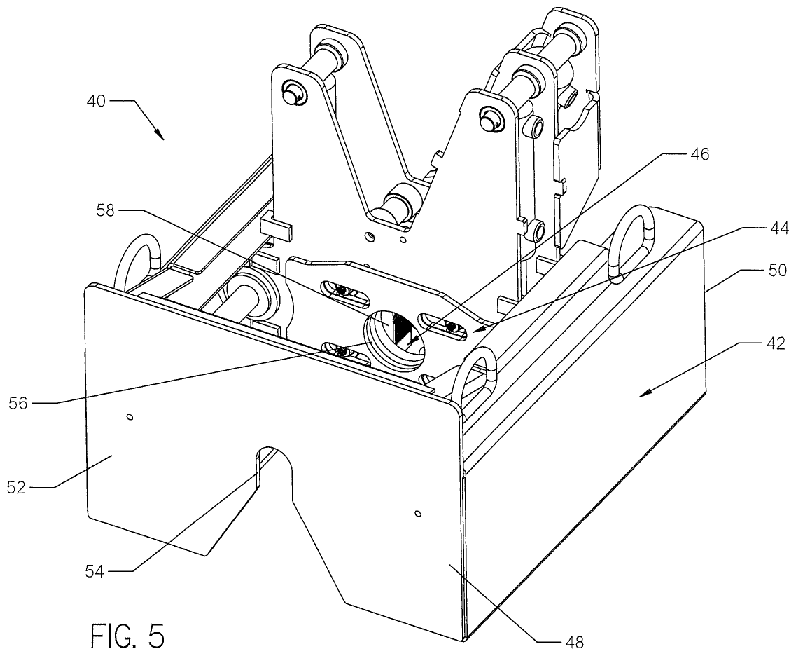

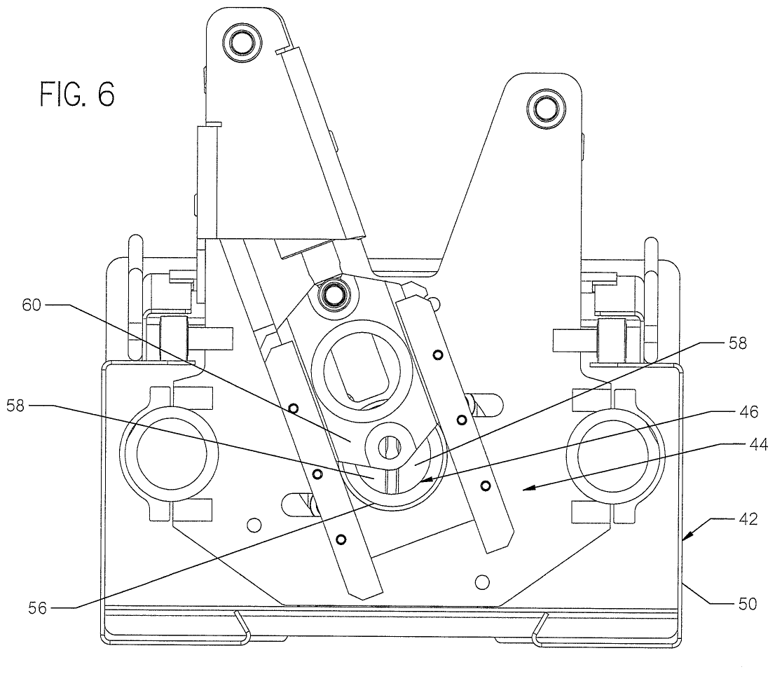

With reference to FIGS. 5 and 6, the pipe extractor 40 is shown in more detail. The pipe extractor 40 is just one example of a pipe extractor that may be used with the methods described herein. Other configurations of pipe extractors known in the art may also be used. The pipe extractor 40 comprises a stationary support structure 42, a carriage 44 movable relative to the support structure 42, and a pipe clamp assembly 46. The carriage 44 is moveable between front and rear ends 48 and 50 of the support structure 42. A reaction plate 52 having a pipe service slot 54 formed therein is positioned at the front end 48.

In operation, the pipe extractor 40 is installed within the second pit 16 so that the reaction plate 52 is engaged with a front wall 55 of the pit 16, as shown in FIG. 3. The reaction plate 52 is also set down over the second free end 32 of the pipe section 38 so that the free end 32 is disposed within the pipe service slot 54.

Continuing with FIGS. 5 and 6, a pipe throat 56 is formed within the carriage 44. When the pipe extractor 40 is installed within the second pit 16, the second free end 32 of the pipe section 38 passes from the pipe service slot 54 into the pipe throat 56. The pipe clamp assembly 46 comprises a set of pipe clamps 58 positioned adjacent the pipe throat 56. The clamps 58 are configured to move between open and closed positions. When in the closed position, as shown in FIG. 6, the clamps 58 grip the portion of the free end 32 disposed within the pipe throat 56. Axial movement of the carriage 44 while gripping the free end 32 pulls the pipe section 38 relative to its surrounding soil 12.

Movement of the carriage 44 and the clamps 58 is powered by a power pack 62 positioned on the ground surface 64 adjacent the second pit 16, as shown in FIG. 3. The pipe extractor 40 is preferably hydraulically powered. Thus, the power pack 62 preferably comprises a hydraulic pump. A set of hoses (not shown) interconnect the pipe extractor 40 and the power pack 62.

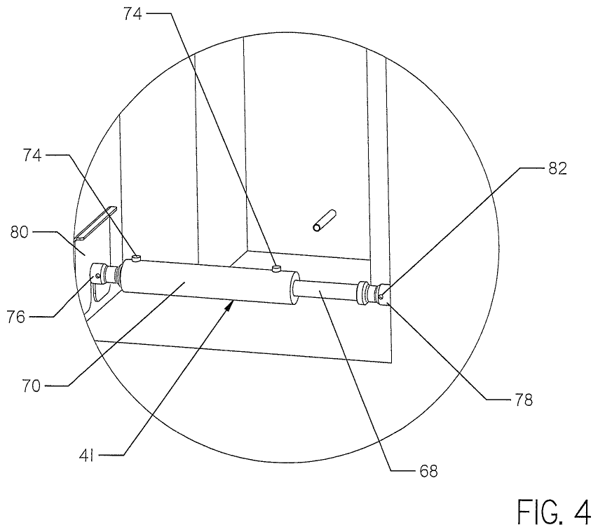

With reference to FIGS. 3 and 4, the linear actuator 41 comprises a piston 68 configured to reciprocate within a cylinder 70. The cylinder 70 is anchored to the second free end 30 via a coupler 76. A shore plate 80 may be supported on the coupler 76 to provide additional reaction load for the cylinder 70.

As the piston 68 extends from the cylinder 70, it engages with a coupler 78 supported on the first free end 26 of the pipe section 38. The piston 68 pushes axially against the coupler 76 and the pipe section 38. The piston 68 continues to push on the pipe section 38 until the pipe section 38 is broken free from the soil 12.

Reciprocation of the piston 68 within the cylinder 70 is powered by a power pack 72 positioned on the ground surface 64. The linear actuator 41 is preferably hydraulically powered. A set of ports 74 are formed in the cylinder 70 for connection to hydraulic hoses (not shown). Such hoses may interconnect the linear actuator 41 and the power pack 72. The amount of force applied to the pipe section 38 by the piston 68 may be varied by adjusting the amount of fluid delivered by the power pack 72 to the linear actuator 41.

If the above method does not loosen the pipe section 38 from the soil 12, the piston 68 may instead be extended and retracted from the cylinder 70 in a cyclical pattern. The piston 68 is releasably connected to the coupler 78 so that it may repeatedly push against the first free end 26 of the pipe section 38. The pipe extractor 40 simultaneously statically pulls on the second free end 32 of the pipe section 38.

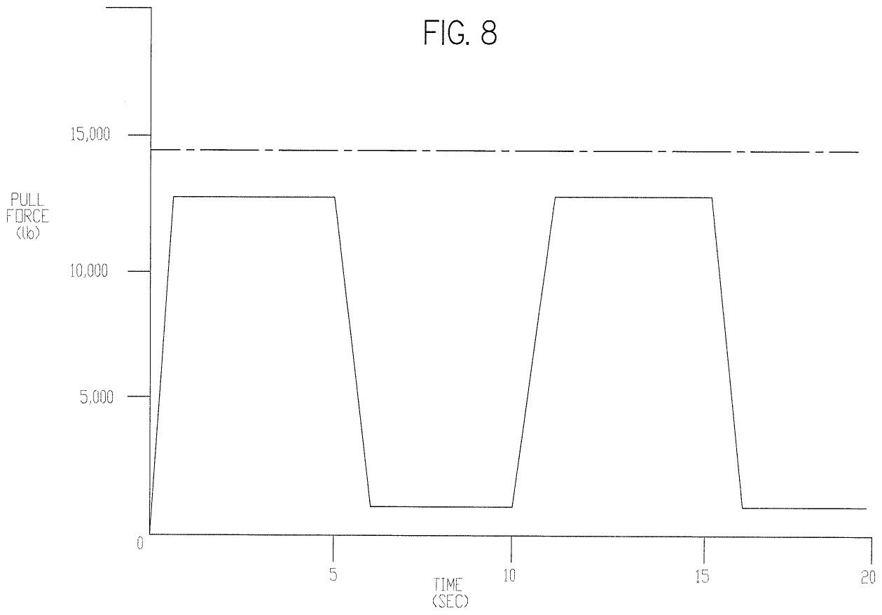

The force applied to the pipe section 38 by the linear actuator 41 and the pipe extractor 40 may be a value just under the yield strength of the pipe section 38. The force may be applied, for example, for five seconds, relax for a few seconds and then repeat. The graph shown in FIG. 8 depicts an example method of cyclic loading. The number of cycles required to loosen the pipe section 38 from the soil may vary. For example, anywhere from five to thirty cycles may be necessary. The period of each cycle, pull force, and number of cycles may be adjusted to fit the needs of the particular extraction operation.

With reference to FIGS. 3 and 4, once the pipe section 38 is loosened from its surrounding soil 12, the linear actuator 41 is removed from the first pit 14. The coupler 78 engaged with the piston 68 may however become stuck on the first free end 26 of the pipe section 38 during operation. One method of removing the coupler 78 from the pipe section 38 is to pull the coupler 78 free using the linear actuator 41. The piston 68 may be attached to the coupler 78 via a pin installed within a pin hole 82 formed in the coupler 78 and the piston 68. Retraction of the piston 68, while attached to the coupler 78, will pull the coupler loose from the first free end 26 of the pipe section 38.

With reference to FIGS. 3, 5, and 6, once the linear actuator 41 has been removed, a new pipe section is attached to the first free end 26 of the pipe section 38. The pipe extractor 40 is then directed to extract the pipe section 38 from its borehole. When extracting the pipe section 38 from its borehole, the clamps 58 pull the pipe section 38 from the soil in small sections as the carriage 44 moves between the front and rear end 48 and 50 of the support structure 42. Thus, the pulling force applied to a pipe section 38 by the pipe extractor 40 is subject to cyclic interruption. A shear blade 60, shown in FIG. 6, cuts the pipe section 38 into smaller sections as the pipe section is extracted from the soil. The new pipe section is pulled into the borehole as the pipe section 38 is removed.

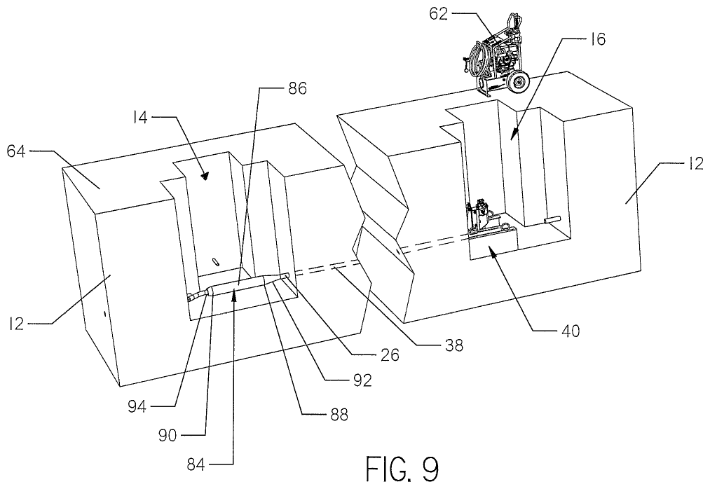

Turning to FIG. 9, another device that may be used to push against the first free end 26 of the pipe section 38 is a pneumatic impact mole 84 known in the art. The mole 84 comprises an elongate body 86 having opposed front and rear ends 88 and 90. A tapered nose 92 is formed adjacent the front end 88. The tapered nose 92 is disposed at least partially within the first free end 26 of the pipe section 38. A coupler (not shown) may be used to help engage the mole 84 with the pipe section 38.

The mole 84 is configured to repeatedly strike an object with its tapered nose 92. An operator may hold the mole 84 steady within the first pit 14 as it operates. The mole 84 is powered by a high pressure pneumatic fluid. The fluid is delivered to the mole 84 through a hose (not shown). A connection point 94 for a hose is formed on the rear end 90 of the mole 84.

In operation, the tapered nose 92 repeatedly strikes the first free end 26 of the pipe section 38. The mole 84 may cycle, for example, at about 3 hertz. The pipe extractor 40 simultaneously statically pulls on the second free end 32 of the pipe section 38 until the pipe section is released from the soil 12.

Once the pipe section 38 is released from the soil 12, the mole 84 may be disengaged from the first free end 26 of the pipe section 38. Disengagement may be accomplished by switching the mole 84 into reverse. In reverse, the mole 84 reciprocates away from the pipe section 38. Once the mole 84 and pipe section 38 are disengaged, the mole 84 is removed from the first pit 14. A new pipe section is then attached to the first free end 26 of the pipe section 38. The pipe extractor 40 is then directed to extract the pipe section 38 from its borehole. The new pipe is installed within the borehole as the pipe section 38 is extracted.

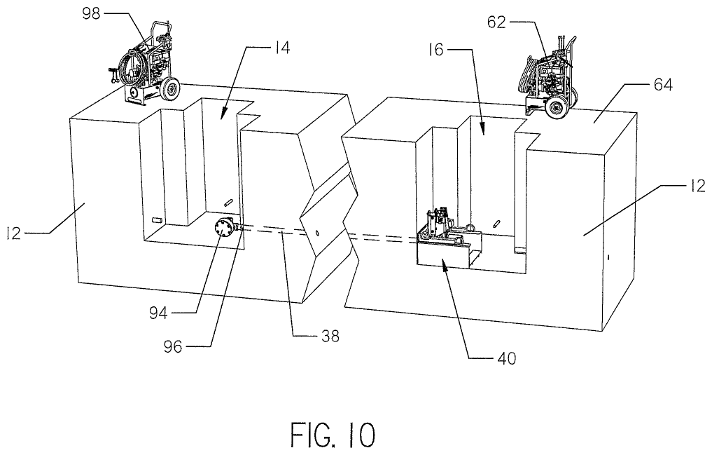

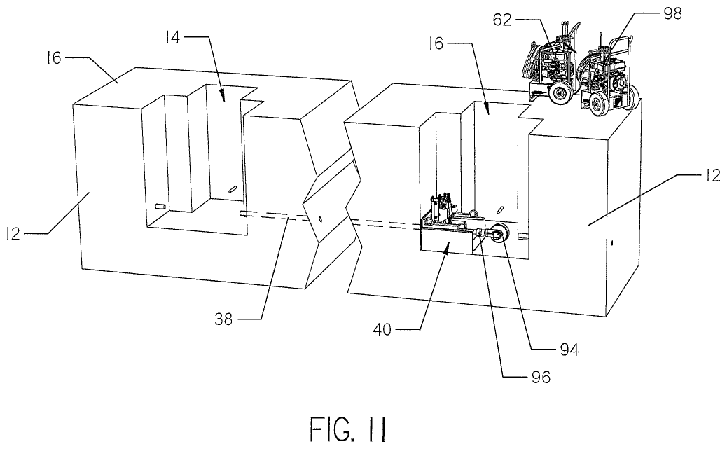

Turning to FIGS. 10 and 11, another method of breaking the friction between the pipe section 38 and the soil 12 is to excite the pipe's natural vibrational frequency. One device that may be used to excite the pipe's natural vibrational frequency is an eccentric mass vibrator 94. The vibrator 94 may be attached to the first free end 26 of the pipe section 38, as shown in FIG. 10. Alternatively, the vibrator 94 may be attached to the second free end 32 of the pipe section 38, as shown in FIG. 11. The vibrator 94 is attached to either end 26 or 32 of the pipe section 38 using a coupler 96.

The vibrator 94 comprises an eccentric mass powered by a hydraulic motor. Rotation of the eccentric mass causes the device to vibrate. A power pack 98 positioned at the ground surface 64 powers the hydraulic motor. A set of hoses (not shown) interconnect the vibrator 94 and the power pack 98. The vibrational frequency created by the vibrator 94 may be varied by adjusting the flow rate of pressurized hydraulic fluid to the vibrator's hydraulic motor. The force waveform produced by the vibrator 94 is fully reversing, meaning that the forces alternate between the right and left side of the pipe section 38.

In operation, the eccentric mass vibrator 94 vibrates the pipe section 38 while the pipe extractor 40 simultaneously statically pulls the second free end 32 of the pipe section 38. Such operation will continue until the pipe section 38 is loosened from the surrounding soil 12.

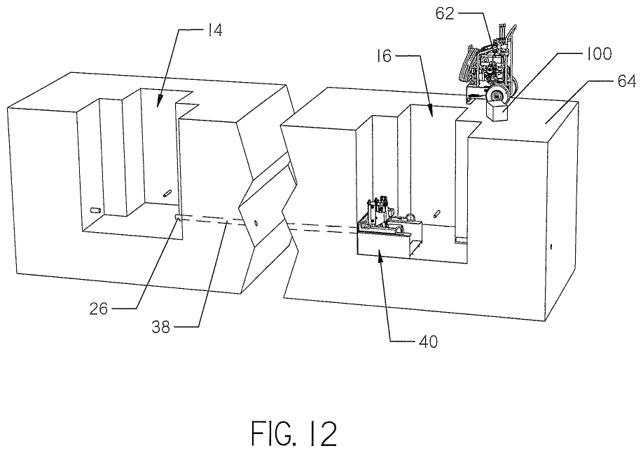

Turning to FIG. 12, another device that may be used to excite the pipe's natural vibrational frequency is a hydraulic exciter 100. An example of a hydraulic exciter is described in U.S. Pat. No. 4,003,203, issued to Vural, the entire contents of which are incorporated herein by reference.

The hydraulic exciter 100 may be integrated into the hydraulic circuit used to operate the pipe extractor 40. The exciter 100 is positioned on the ground surface 64 adjacent the power pack 62. The exciter 100 is coupled to the power pack 62 so that it vibrates hydraulic fluid delivered to the pipe extractor 40. Thus, a vibratory force is superimposed on the static force applied by the pipe extractor 40.

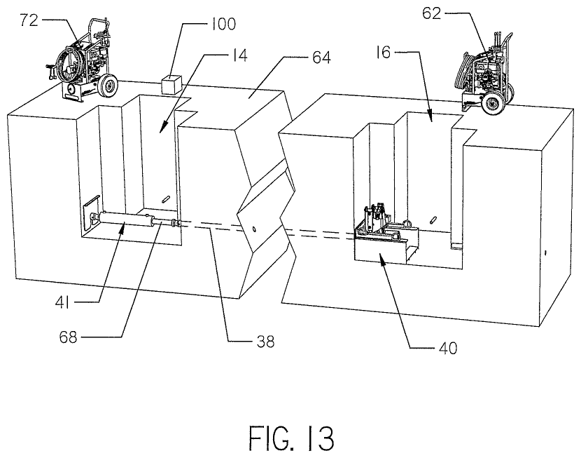

Turning to FIG. 13, the hydraulic exciter 100 may also be integrated into the hydraulic circuit used to operate the linear actuator 41. The exciter 100 is positioned on the ground surface 64 adjacent the power pack 72. The exciter 100 is coupled to the power pack 72 so that it vibrates hydraulic fluid delivered to the linear actuator 41. Thus, a vibratory force is superimposed on the static force applied to the first free end 26 of the pipe section 38 by the piston 68. Other devices known in the art that are capable of vibrating or exciting the pipe's natural vibrational frequency may also be used in conjunction with the pipe extractor.

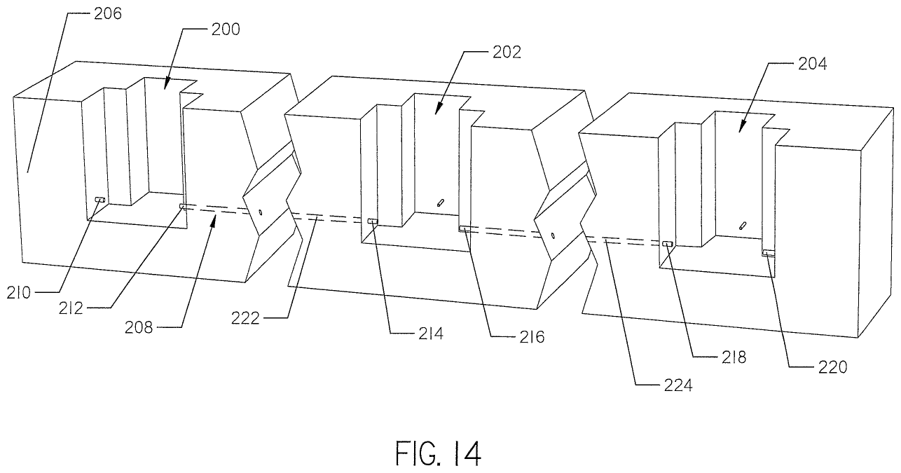

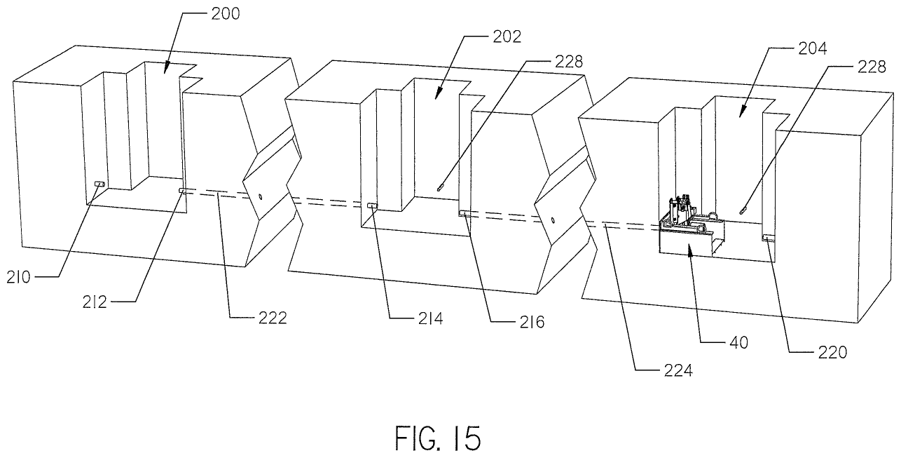

Turning to FIGS. 14 and 15, the friction between a buried pipe and the soil may also be broken using only a pipe extractor. As discussed above, a pipe extractor alone can normally extract a pipe having a length of about 100 feet. Thus, one method of extracting an elongate main pipeline is to cut the pipeline into smaller sections and individually extract each section. Such method requires multiple excavation pits to be formed above the main pipeline so that multiple sections of the main pipeline are exposed.

Continuing with FIG. 14, aligned and spaced first, second, and third pits 200, 202, and 204 are formed in the soil 206 above an elongate main pipe 208. The pipe 208 has a length of about 100 feet between each pit 200, 202, and 204. The exposed pipe sections within each pit 200, 202, and 204 have been cut to form opposing free pipe ends 210 and 212, 214 and 216, and 218 and 220 within each respective pit. The end 212 in the first pit 200 is joined to the end 214 in the second pit 202 to form a first pipe section 222. Likewise, the end 216 in the second pit 202 and the end 218 in the third pit 204 are joined to form a second pipe section 224.

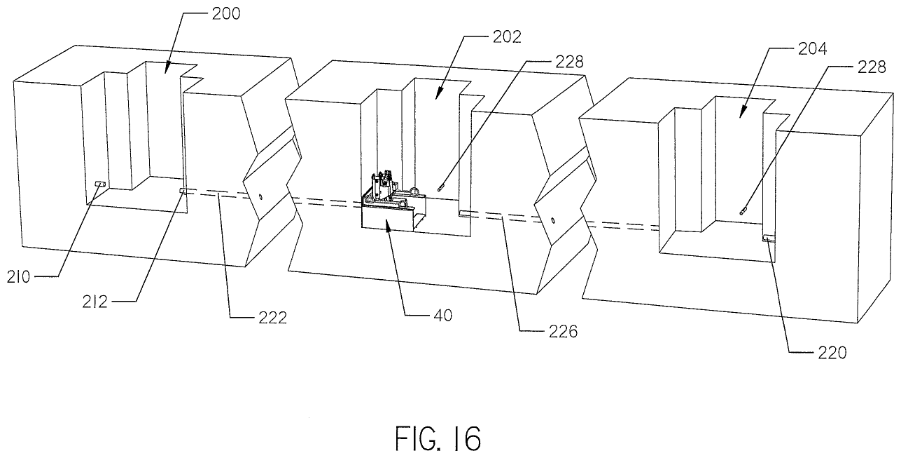

Turning to FIG. 15, the pipe extractor 40 is positioned within the third pit 204 and engaged with the end 218 of the second pipe section 224. Because the pipe section 224 has a length of about 100 feet, the pipe extractor 40 functions as normal to grip and pull the pipe section 224 from its borehole. A new pipe section 226, shown in FIG. 16, may be attached to the end 216 of the pipe section 224 and pulled into the borehole as the pipe section 224 is removed.

Turning to FIG. 16, once the pipe section 224 has been removed and replaced with the new pipe section 226, the pipe extractor 40 is moved to the second pit 202. The pipe extractor 40 is installed within the second pit 202 so that it is engaged with the end 214 of the first pipe section 222. A new pipe is attached to the end 212 of the pipe section 222 in the first pit 200. Once the new pipe is attached the pipe section 222, the pipe extractor 40 grips and pulls the pipe section 222 from its borehole. The new pipe section is installed within the borehole as the pipe section 222 is removed.

The above described method will continue until the entire main pipe 208 has been extracted and new pipe sections have been installed. After all of the new pipe sections are installed, the new pipe sections are then joined together within each pit 200, 202, and 204 to form a continuous pipe. Likewise, the new pipe sections are also joined to any exposed lateral pipe ends 228 within each pit 200, 202, and 204. FIGS. 14-16 show the above described method being employed using three excavation pits. However, the method may be employed using more than three pits, if needed.

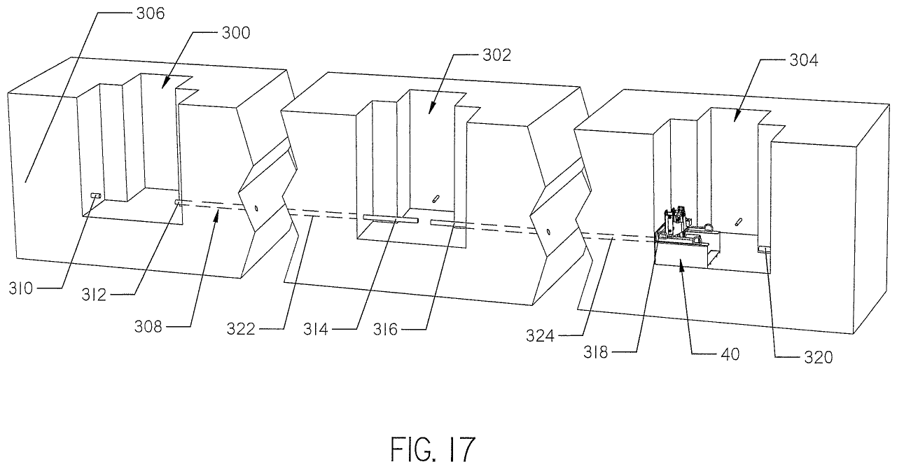

Turning to FIG. 17, the above described method may be modified so that the pipe extractor does not need to be moved to each pit. Rather than individually extracting each section of pipe between each pit, the sections of pipe may simply be individually loosened from the soil. Once each section is loosened, the entire pipe may be extracted from the same pit.

FIG. 17 shows aligned and spaced first, second, and third pits 300, 302, 304 formed in the soil 306 above an elongate main pipe 308. The pipe 308 has a length of about 100 feet between each pit 300, 302, 304. The exposed pipe sections within each pit 300, 302, 304 have been cut to form opposing free pipe ends 310 and 312, 314 and 316, and 318 and 320 within each respective pit. In contrast to the method depicted in FIGS. 14-16, the ends 314 and 316 within the second pit 302 are much closer together than the ends 310, 312 and 318, 320 within the first and third pits 300 and 304. The end 312 in the first pit 300 is joined to the end 314 in the second pit 302 to form a first pipe section 322. Likewise, the end 316 in the second pit 302 and the end 318 in the third pit 304 are joined to form a second pipe section 324.

The pipe extractor 40 is installed within the third pit 304 and engaged with the end 318 of the pipe section 324. The pipe extractor 40 applies a ground-dislodging axial force to the end 318 of the pipe section 324 until the pipe section is loosened from its surrounding soil.

Once the pipe section 324 is broken free from the surrounding soil, the ends 314 and 316 within the second pit 302 are rejoined. The pipe extractor 40 then applies a second ground-dislodging axial force to the end 318 of the pipe section 324 within the third pit 304. The force is applied until the pipe section 322 is loosened from the surrounding soil.

Once the pipe section 322 is loosened from the soil, a new elongate pipe section may be attached to the end 312 of the pipe section 322 within the first pit 300. The pipe extractor 40 then operates to extract both pipe sections 322 and 324 from the soil. The new elongate pipe section is installed within the borehole as the pipe sections 322 and 324 are removed. FIG. 17 shows the above described method being employed using three excavation pits. However, the method may be employed using more than three pits, if needed.

In an alternative embodiment, a linear actuator may be positioned parallel to the ends 314 and 316 within the second pit 302. The linear actuator may be clamped to the sides of the ends and the cylinder may react off of a shore plate engaged with a wall of the pit. The linear actuator may apply a static or cyclic load force to the pipe section 324 to help loosen the pipe section from the soil. The same method may also be used without separating the pipe 308 within the second pit. Rather, the pipe may be continuous within the second pit and the linear actuator may clamp to the sides of the pipe.

The methods described in FIGS. 1-17 may be employed without disposing a cable through the pipe sections to be removed. A cable, like that described in U.S. Pat. No. 7,128,499, issued to Wentworth, may be disposed through the pipe sections, if needed, to actually extract the pipe sections from the surrounding soil.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

In the event of any inconsistent usages of terms between this document and any documents incorporated by reference herein, the usage in the incorporated reference(s) should be considered supplementary to that of this document. For irreconcilable inconsistencies, the usage in this document controls.

Changes may be made in the construction, operation and arrangement of the various parts, elements, steps and procedures described herein without departing from the spirit and scope of the invention as described in the following claims.

1. A system comprising:
a pipe having a first end, a second end, and a middle section, in which the middle section is below ground;
a device engaged with the first end of the pipe and selected from a group consisting of a linear actuator or a pneumatic impact mole; and
an apparatus, comprising:
a stationary support structure;
a carriage movable relative to the stationary support structure; and
a pipe clamp assembly supported by the carriage and in gripping engagement with the second end of the pipe.

2. The system of claim 1 in which no cable is disposed within the pipe.

3. The system of claim 1 in which the selected device is the linear actuator and the linear actuator comprises:
a hydraulic cylinder having a reciprocating piston;
in which the piston is engageable with the first end of the pipe.

4. The system of claim 1 in which the selected device is the pneumatic impact tool and the pneumatic impact tool comprises:
an elongate body having opposed front and rear ends;
a tapered nose formed adjacent the front end and disposed at least partially within the first end of the pipe; and
a connection point for a pneumatic hose.

5. The system of claim 3, further comprising:
a hydraulic pump in fluid communication with the linear actuator; and
a hydraulic exciter coupled to the hydraulic pump.

6. A method of using the system of claim 3, comprising:
pushing the piston against the first end of the pipe;
gripping the second end of the pipe with the pipe clamp assembly; and
impelling the carriage to move relative to the support structure while the pipe remains gripped by the pipe clamp assembly.

7. A method of using the system of claim 3, comprising:
extending and retracting the piston in a cyclical pattern;
gripping the second end of the pipe with the pipe clamp assembly; and
impelling the carriage to move relative to the support structure while the pipe remains gripped by the pipe clamp assembly.

8. A method of using the system of claim 4, comprising:
striking the first end of the pipe with the tapered nose of the tool;
gripping the second end of the pipe with the pipe clamp assembly; and
impelling the carriage to move relative to the support structure while the pipe remains gripped by the pipe clamp assembly.

9. The system of claim 1 in which the pipe has a length greater than 200 feet.

10. A system, comprising:
an elongate underground pipe having a first exposed end, an opposed second exposed end, and a natural vibrational frequency;
a first apparatus mechanically coupled to the pipe and configured to excite the pipe's vibrational frequency; and
a second apparatus mechanically coupled to the pipe and configured to impart a pulling force to one of the exposed ends of the pipe.

11. The system of claim 10 in which the first apparatus and the second apparatus are coupled to the pipe at the same exposed end.

12. The system of claim 10 in which the first apparatus is coupled to the pipe at its first exposed end, and the second apparatus is coupled to the pipe at its second opposed end.

13. The system of claim 10 in which the first apparatus is a hydraulic exciter.

14. The system of claim 10 in which the first apparatus is an eccentric mass vibrator.

15. The system of claim 10 in which the second apparatus comprises:
a stationary support structure;
a carriage movable relative to the stationary support structure; and
a pipe clamp assembly supported by the carriage and in gripping engagement with the second end of the pipe.

16. The system of claim 10 in which the applied pulling force is steady.

17. The system of claim 10 in which the applied pulling force is subject to cyclical interruption.

18. A method of extracting an elongate underground pipe having exposed sections extending through a plurality of spaced pits, included adjacent first and second pits, comprising:
within the first pit, cutting the pipe section therein to form a ground-entering pipe segment having a first free end and a ground-entering pipe segment having a second free end;
cutting the pipe section within the second pit so as to form two ground-entering pipe segments;
applying a first ground-dislodging axial force to the pipe segment terminating at the first free end;
thereafter joining the pipe segments within the second pit; and
thereafter applying a second ground-dislodging force to the pipe segment terminating at the free first end.

19. The method of claim 18 in which each of the steps of applying a ground-dislodging axial force are performed within the same pit.

20. The method of claim 19 in which the same pit is the first pit.

21. The method of claim 18 in which the plurality of pits includes a third pit spaced from and aligned with both the first and second pits, and further comprising:
before applying the second ground-dislodging axial force, cutting the pipe section within the third pit so as to form two ground-entering pipe segments;
after applying the second ground-dislodging axial force, joining the two pipe segments within the third pit; and
thereafter applying a third ground-dislodging axial force to the pipe segment terminating at the first free end.

22. A method of extracting an elongate underground pipe having exposed sections extending through a plurality of spaced pits, included adjacent first and second pits, comprising:
within the first pit, cutting the pipe section therein to form a ground-entering pipe segment having a first free end and a ground-entering pipe segment having a second free end;
within the second pit, cutting the pipe section therein to form a ground-entering pipe segment having a first free end and a ground-entering pipe segment having a second free end;
applying a first ground-dislodging axial force to the pipe segment terminating at the first free end within the first pit; and
thereafter applying a second ground-dislodging axial force to the pipe segment terminating at the first free end within the second pit.
